(19) United States
(12) Patent Application Publication
(10) Pub. No.: US 2004/0131070 A1
(43) Pub. Date: Jul. 8, 2004

(54) System and method to facilitate simultaneous transmission of voice and data between a PC and remote telephony device

(76) Inventor: Gary Rogalski, Richmond (CA)

Correspondence Address: Lawrence D. Eisen, SHAW PITTMAN LLP, 1650 Tysons Boulevard, McLean, VA, 22102, US

(21) Appl. No.: 10/401,796

(22) Filed: Mar. 31, 2003

Related U.S. Application Data
(60) Provisional application No. 60/438,531, filed on Jan. 8, 2003.

(51) Int. Cl. H04L 12/66

(52) U.S. Cl. 370/419

(57) ABSTRACT

A system and method for facilitating transmission of voice and data between a PC and a remote telephony device. A cordless telephone system having a base station and at least one cordless handset also includes a first modem, caller ID functionality, and telephone answering machine functionality. A computer, having a second modem and a sound card is connected to the public switched telephone network (PSTN) via an adapter that has a controllable switch. After a connection is established between the first and second modems with the switch in a first configuration, the adapter is controlled to put the switch in a second configuration such that incoming signals transmitted from the base station over the PSTN are routed to the sound card. Accordingly, both data and audible signals can be retrieved by the computer from the base station over the same PSTN connection.

This application claims the benefit of U.S. Provisional Application No. 60/438,531, filed Jan. 8, 2003, which is herein incorporated by reference in its entirety.

### BACKGROUND

1. Field of the Invention

The present invention is related to improvements in telephone and computer systems. More particularly, the present invention is related to improvements in remotely accessing, over the public switched telephone network (PSTN), a remote telephony device such as a cordless telephone base station from which both voice and data information can be obtained.

2. Background of the Invention

It is well-known to include a V.90 type dial-up modem in computers, such as laptop computers that are portable and therefore transportable to different locations. Such modems are employed to, among other things, access files from remote servers, “surf” the Internet, and exchange data with other computers. Typically, the modems operate over the public switched telephone network (PSTN) and can therefore access almost any remote device that is also connected to the PSTN and that has complementary modem capabilities. Also known are telephone answering machines and services that allow users to call the machine or service from a remote location and, using DTMF tones to control the system or service, retrieve telephone messages that have been previously stored.

Heretofore, however, there has been no attempt to combine the potential of a dial-up modem with the available functionality of a telephone system that permits remote access thereto.

### SUMMARY OF THE INVENTION

The present invention provides several unique advancements in the field of remote data access. At a high level, aspects of the invention facilitate the transmission of both (i) data via a modem compatible with standard dial up modem protocols and (ii) audible voice to a computing device, such as a laptop computer, and both via a single PSTN interface. That is, the present invention allows, for example, for the retrieval of previously-recorded telephone messages and storage of these messages into a remote computing device, as well as for the retrieval and storage of data using the same PSTN interface.

One of the many advantages of the present invention is the ability not just to audibly play messages on the computer that may have been stored on an answering machine associated with a telephone system in another location, but also to store the messages locally for later retrieval. Another, perhaps even more significant, advantage of the present invention is the ability to have both a data and voice connection to the laptop computer over a single PSTN interface. With this latter feature, it is possible to transmit not only previously-recorded messages from, e.g., an answering machine, but also to transmit data such as caller ID information that may have been recorded by the telephone system, or, video images that may be available from, e.g., a cordless telephone system that comprises video monitoring capability. Thus, in accordance with the present invention, a remote computer that is connected to the PSTN can receive several different types of information, including voice and data, from a remotely located base station, such as a base station associated with a cordless telephone system.

In one embodiment of the invention, a base unit or station of a cordless telephone system is equipped with an integrated answering system and video monitoring system. Once the laptop, or, more generally, personal computer (PC) has completed downloading an image from the base station, the answering machine portion of the base station is preferably automatically triggered, through modem-to-modem communication, to stop transmitting data and to start playing its stored messages over the same PSTN line.

Another aspect of the present invention is software that runs on the laptop computer that provides a simple interface to the user to select between several available options, including image download only, image and message download, message download only, or real time message playback only without storage. The foregoing functionality is preferably made possible by providing an external hardware block, or adapter, that is capable of routing data signals to the internal V.90 modem of the laptop and audio signals to the laptop's soundcard interface.

The functionality described above as well as other features and attendant advantages thereof will be more fully understood upon a reading of the following detailed description in combination with the associated drawings.

### BRIEF DESCRIPTION OF THE DRAWINGS

FIG. 1 shows an exemplary connection between a laptop computer and a cordless telephone base station across the PSTN in accordance with the present invention.

FIG. 2 is a detailed view of an adapter that is connected between the laptop computer and PSTN in accordance with the present invention.

### DETAILED DESCRIPTION

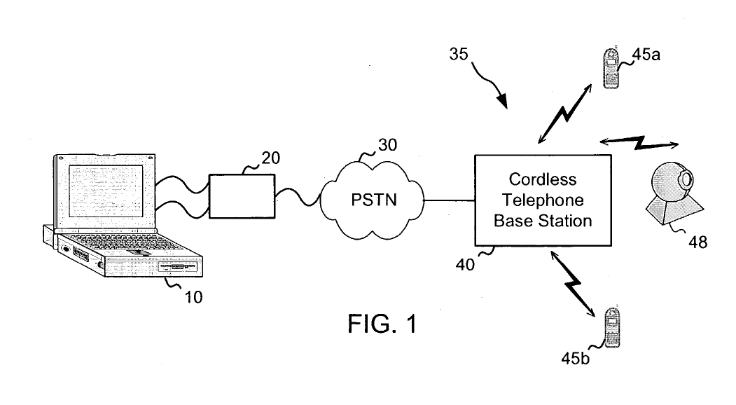

As explained above, the present invention provides several unique advancements in the field of remote data access. In accordance with the present invention it is possible to receive from a remote location both (i) data via a modem interface compatible with standard dial-up modem protocols and (ii) voice, all via a single PSTN interface connected to a computing device, such as a notebook or laptop computer. FIG. 1 depicts an exemplary implementation of the present invention in which laptop computer 10 is connected to PSTN 30 via an adapter module 20 (which is described in more detail below). Also connected to the PSTN is, in this case, a cordless telephone base station 40. Those skilled in the art will appreciate, however, that other types of equipment could be employed instead of a cordless telephone base station, including other electronic equipment sufficiently equipped to communicate with laptop 10 via a modem over PSTN 30. While the present disclosure describes the present invention in the context of a cordless telephone implementation, this is exemplary only and is not intended to limit the scope of the invention, which is defined only by the claims below.

Referring still to FIG. 1, the overall cordless telephone system 35 preferably includes base station 40, as already mentioned, as well as one or more cordless handsets 45a, 45b, along with a cordless camera module 48 that is in communication with at least base station 40, but that may also be in communication (directly or indirectly) with any one of cordless handsets 45a, 45b.

In addition, cordless telephone system 35 preferably includes answering machine and caller ID functionality sufficient to at least capture and store, respectively, messages and calling number information.

Finally, cordless telephone system 35 preferably also comprises modem functionality sufficient to communicate using, for example, the V.90 standard, whereby laptop 10 and base station 40 can communicate with each other over PSTN 30.

With the architecture depicted in FIG. 1, it is possible in accordance with the present invention to “tap into” base station 40 with laptop 10 and retrieve and store previously-stored messages, as well as receive data that might comprise streaming, or a snapshot of, video from cordless/wireless camera 48. In an embodiment of the invention, video images captured by camera 48 are preferably first passed to base station 40 from which they can be subsequently retrieved by laptop 10.

There are several ways to play messages at laptop computer 10 that are stored in the answering machine component of cordless telephone system 35. In one way, the stored messages are first digitized and sent as digital data to laptop computer 10 using laptop computer's 10 modem. In another way, a sound card 12 in laptop computer 10 is employed to capture the audible signal that is played by the answering machine component of base station 40. It is also possible to digitize received analog (audible) data or to digital to analog convert received digitized data for playback.

Accordingly, it is possible to not only audibly play messages on the computer that have been stored on the answering machine, but it is also possible to store them locally for later retrieval by capturing transmitted data.

Thus, in accordance with the present invention, a remote computer that is connected to the PSTN via its dial-up modem (and, possibly sound card) can receive several different types of information, including voice and data, from a base station, such as a base station associated with a cordless telephone system.

In a preferred embodiment, a software application runs on laptop 10 that prompts the user to enter their home phone number (or other number at which a base station is located) and then further prompts the user to select one of several options, including:

image download only;

image and message download;

message download only (for storage and subsequent palyback); or

real time message playback only without storage.

Once a selection has been made, the laptop's modem dials the entered phone number and establishes a data connection with base station 40. Once this is accomplished, video image download can commence. In one embodiment, only a snapshot image is transmitted to laptop 10. In another embodiment, streaming video can be transmitted to the extent the data rate of the paired modems can support it. In still another embodiment, if the user selects a download option that includes audio, then the software running on laptop 10 preferably prompts a microcontroller (not shown) in base station 40 to stop sending data via the modem and begin audibly playing stored voice messages over the PSTN link.

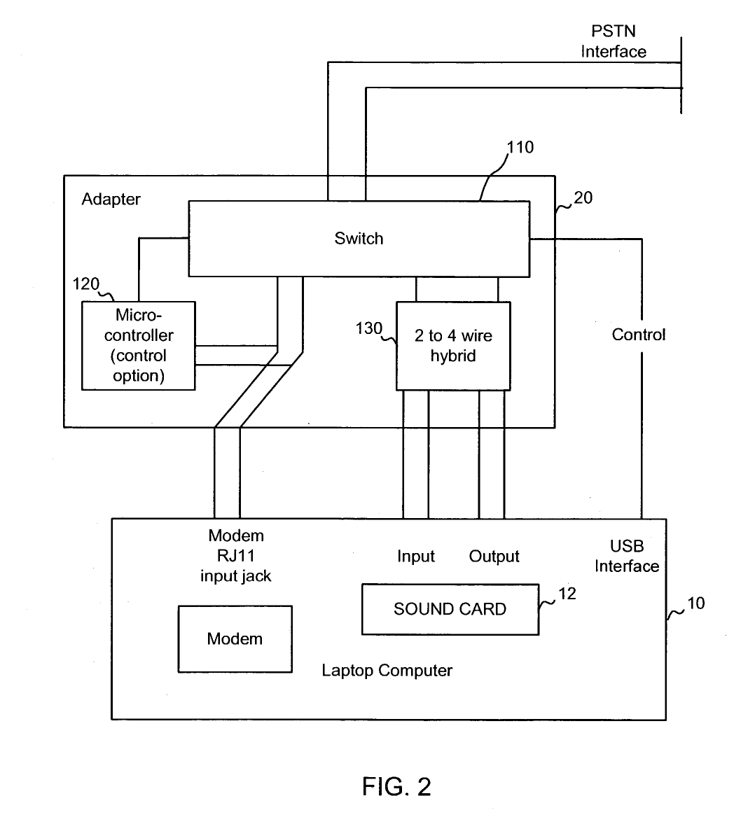

At the laptop end, referring now to FIG. 2, a switch 110 in adapter 20 routes the incoming audio to an input of sound card 12 hosted by laptop 10 instead of the modem input. The internal switch mechanism 110 preferably provides an “off-hook” condition to the PSTN line in both routing conditions so the connection to the central office of the PSTN is not lost. In accordance with embodiments of the present invention, there is also preferably provided a means to communicate between laptop 10 and adapter 20 to control when to switch from modem to sound card. This “means” preferably comprises the line labeled as “control” in FIG. 2 and could be in the form of a USB interface (for example), as shown. However, a USB connection is just one possible means of implementing the desired control mechanism. In an alternative embodiment, the external control line could be removed by adding a microcontroller 120 that can decode AT commands from the laptop modem and use the decoded commands as the control mechanism to switch between modem and sound card. As can be seen in FIG. 2, adapter 20 preferably also includes a two-to-four wire hybrid 130 to allow differentiation between input and output signals for sound card 12.

Thus, as will be appreciated by those skilled in the art, the present invention provides the capability of connecting a laptop computer or other portable electronic device having a modem to a base station, such as a cordless telephone system base station, over the PSTN. The laptop computer preferably has a software program that initiates a call placed by the laptop-end modem to the base station, which itself includes modem functionality. Once a modem-to-modem connection is established, data can be easily exchanged between the laptop computer and the base station. Information can be retrieved from the remote base station and commands can be sent to the remote base station. Once data, such as caller ID data, or even video images, are retrieved from the base station and/or stored on the laptop computer, an adapter including a switch that is disposed between the laptop computer and the PSTN is controlled to switch the PSTN line to be connected to a sound card hosted by the laptop computer. The software running on the laptop computer can then be controlled to send DTMF tones to the base station to cause the base station to begin playing audible voice messages that have been stored at the base station. It is noted that DTMF tones need not necessarily be used, and, instead, before the laptop's modem connection is switched to the sound card, a modem command can be sent to the base station commanding it (the base station) to begin playing the audible voice messages over the PSTN line.

While the present invention has been described as a mechanism by which audio can be routed to a sound card and data gets routed to a PC modem, it is also within the scope of the present invention to have an embodiment wherein audio is routed through the modem, which is operating in a “pass through” mode, thereby negating the need for the external switch and control hardware.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of facilitating communication between a PC and a remote telephony device, comprising:
establishing a modem-to-modem connection between a PC and a remote telephony device;
retrieving digital data from the remote telephony device over the modem-to-modem connection;
causing the telephony device to transmit audible voice signals; and
routing the audible voice signals to a sound card hosted by the PC to play the audible voice signals.

2. The method of claim 1, wherein the PC is a laptop computer.

3. The method of claim 1, wherein the telephony device comprises a cordless telephone system.

4. The method of claim 1, wherein the digital data comprises caller ID information.

5. The method of claim 1, wherein the audible voice signals comprise previously-stored voice messages.

6. The method of claim 1, further comprising:
capturing video signals; and
retrieving the video signals from the remote telephony device.

7. A system for facilitating transmission of voice and data between a PC and a remote telephony device, comprising:
a cordless telephone system comprising a base station and at least one cordless handset, the cordless telephone system further comprising a first modem, caller ID registering, and telephone answering machine components; and
an adapter, including a switch, connectable between (i) a computer comprising a second modem and a sound card and (ii) the public switched telephone network (PSTN),
wherein after a connection is established between the first and second modems with the switch in a first configuration, the adapter is operable to put the switch in a second configuration such that incoming signals transmitted from the base station over the PSTN are routed to the sound card.

8. The system of claim 7, further comprising a cordless camera that is in communication with the base station.

9. The system of claim 7, wherein video data is transmitted between the first and second modems.

10. The system of claim 7, wherein the adapter is in communication with the computer via a USB connection.

11. The system of claim 7, wherein the adapter further comprises a microcontroller.

12. The system of claim 7, wherein the computer further comprises a software program that is operable to initiate the connection that is established between the first and second modems.

13. The system of claim 12, wherein the software program is operable to provide options for a user to select.

14. The system of claim 13, wherein the options comprise at least one of image download only, image and message download, message download only, and real time message playback only without storage.

15. The system of claim 7, wherein the adapter is operable to provide an off hook condition to the PSTN.

16. A system for transmitting voice and data to a PC from a remote telephony device, comprising:
a cordless telephone system comprising a base station and at least one cordless handset, the base station comprising a first modem, and
an adapter, including a switch, connectable between (i) a PC comprising a second modem and a sound card and (ii) the public switched telephone network (PSTN),
wherein after a connection is established between the first and second modems with the switch in a first configuration, the adapter is operable to place the switch in a second configuration such that incoming signals transmitted from the base station over the PSTN are routed to the sound card.

17. The system of claim 16, wherein the cordless telephone system further comprises video capability.

18. The system of claim 17, wherein digital video imagery is sent between the first and second modems.

19. The system of claim 16, wherein at least one previously-recorded telephone message stored at the base station is routed to the sound card when the switch is in the second configuration.

20. The system of claim 16, wherein the adapter is controllable from the PC.

21. The system of claim 16, wherein the cordless telephone system detects and stores caller ID information.

22. The system of claim 21, wherein the caller ID information is sent between the first and second modems.
